(19) United States
(12) Patent Application Publication
(10) Pub. No.: US 2006/0118655 A1
(43) Pub. Date: Jun. 8, 2006

(54) Concrete mixer

(76) Inventor: Robert Leslie Pickering, Northern Ireland (GB)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/270,828

(22) Filed: Nov. 10, 2005

(30) Foreign Application Priority Data
Nov. 11, 2004 (GB) 04 24 929.8

(51) Int. Cl. B05B 3/06

(52) U.S. Cl. 239/251; 239/261; 239/225.1

(57) ABSTRACT

A pan type concrete mixer in which a plurality of sprayers are inserted in a substantially equl-spaced arrangement in a lid of the pan to extend into the chamber. Each sprayer has a head with two diametrically-opposite jet nozzles. Each head is capable of substantially 360° rotation. Each sprayer is connectable to a pressurized water supply whereby passage of water into each sprayer causes rotation of the respective head and jet discharge of spray from the respective nozzles around the inside of the chamber.

### CROSS-REFERENCE TO RELATED APPLICATIONS

This application is based on United Kingdom Patent Application No. 0424929.8 filed Nov. 11, 2004, upon which priority is claimed.

### BACKGROUND OF THE INVENTION

1. Field of the Invention

This invention relates to a concrete mixer in which materials to be mixed to form concrete, mortar or the like (hereinafter, concrete) are locatable in a chamber of a stationary body or pan and are mixed by rotation of paddles in the chamber. Such mixers are known as pan mixers or planetary pan mixers.

Hereinafter such a concrete mixer will be referred to as “of the type stated”.

2. Description of the Prior Art

A requirement of known concrete mixers is that at the end of a mixing period, such as a day, the mixer must be washed out ready for re-use after a time interval. This is presently done manually with the use of a hose and is disadvantageous since it is labor intensive, time consuming and therefore expensive.

### OBJECT AND SUMMARY OF THE INVENTION

An object of the present invention is to mitigate or obviate this disadvantage.

Accordingly, the present invention is a concrete mixer of the type stated in which a plurality of sprayers are inserted in a substantially equi-spaced arrangement in a wall of the pan to extend into the chamber, each sprayer having a head with at least one jet nozzle, each head being capable of substantially 360° rotation, each sprayer being connectable to a pressurized water supply whereby passage of water into each sprayer causes rotation of the respective head and jet discharge of spray around the inside of the chamber.

Preferably, the sprayers are mounted in the top wall or lid of the pan. The head of each sprayer beneficially has two diametrically-opposite jet nozzles.

Preferably also, a unit is provided having a framework in which a corresponding combined prime mover and pump is provided for each sprayer. A tank for holding water is desirably provided above said combined prime movers and pumps with each pump being supplied with water therefrom, the pumps each communicating with the respective sprayers.

Preferably further, one of said combined prime mover and pumps is provided with a three port diverter valve, one port being connected to the tank, a second port to a sprayer and a third port connected to a lance sprayer for use in cleaning the outside of the mixer, the valve being to divert water from the second to the third port and vice versa. The valve is beneficially electrically operable.

### BRIEF DESCRIPTION OF THE DRAWINGS

An embodiment of the present invention will be described herein below by way of example, with reference to the accompanying drawings, in which:—

FIG. 1 is a plan view of a concrete pan mixer having three sprayers mounted in equi-spaced relationship in a top wall of the mixer according to the present invention;

FIG. 2 is a detail of a cross-sectional view of the pan mixer showing one sprayer;

FIGS. 3A and 3B are side views of a unit showing a framework mounting a tank and respectively three and four combined prime movers and pumps on two shelves therebelow; and

FIG. 4 is a rear view of the unit.

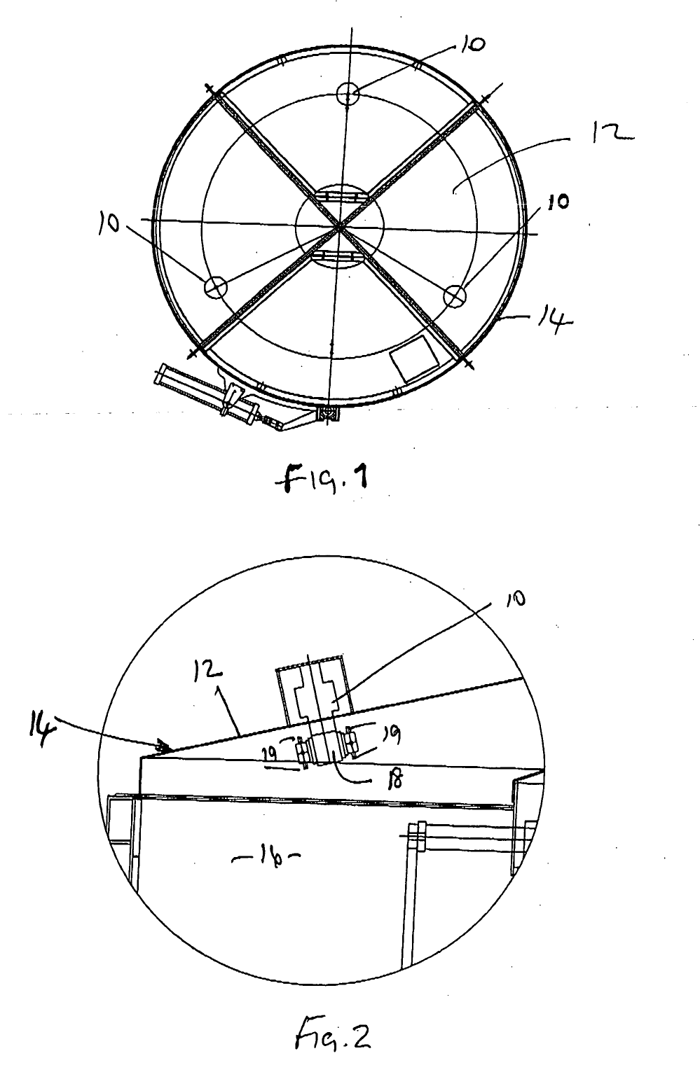

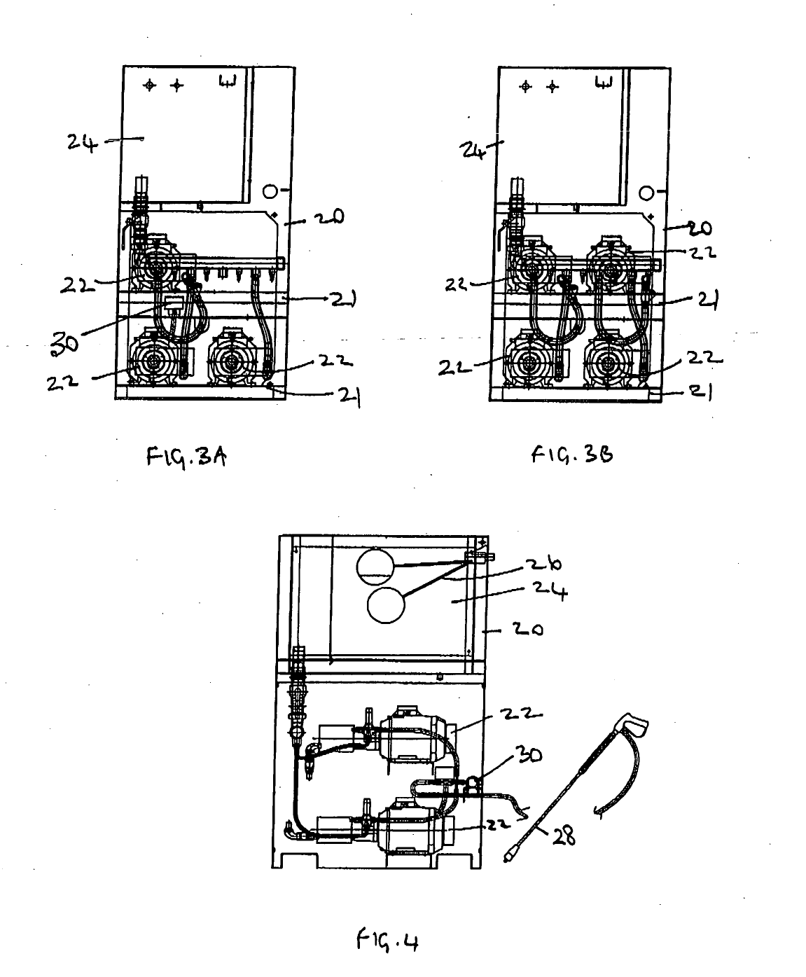

### DESCRIPTION OF THE PREFERRED EMBODIMENTS

Referring to the drawings, a concrete mixer of the type stated has a plurality of three sprayers 10 inserted in a substantially equi-spaced arrangement in a top wall or lid 12 of the pan 14 to extend into the chamber 16. Inside the chamber 16, each sprayer 10 has a head 18 with two diametrically-opposite jet nozzles 19. Each head 18 is capable of substantially 360° rotation through a liquid tight universal coupling. Each sprayer 10 is connectable to a pressurized water supply. A unit is provided having a framework 20 with two vertically-spaced shelves 21 on a lower shelf of which two combined prime mover and pumps 22 are provided with one prime mover and pump 22 being provided on the upper shelf, one combination for each sprayer 10. A tank 24 for holding water is provided above the shelves 21 supporting said combined prime movers and pumps 22. The pump in each combination is supplied with water from the tank 24. The pumps communicate with the respective sprayers 10. The tank 24 is connected to a water supply (not shown) through a ballcock valve 26 and is replenished with water automatically with fall of water level in the tank 24.

The combined prime movers, i.e. electrical motors, and pumps 22 are linked to a power supply (not shown).

An additional fourth combined prime mover and pump 22 (as shown in FIG. 3B) is supplied with water from the tank 24 and connected to a hand-held lance sprayer 28 for use in cleaning the outside of the mixer.

Alternatively, the third combined prime mover and pump 22 (as shown in FIG. 3A) is provided with a three port diverter valve 30, one port being connected to the tank, a second port to a sprayer 10 and a third port connected to the lance sprayer 28. The valve 30 is to divert water from the second port to the third port and vice versa. The valve 30 is preferably electrically-operated.

In use, after the mixing and discharge operations are over, the combined motors and pumps 22 are energised for the washing procedure and the sprayers 10 discharge spray internally of the chamber to wash out the mixed residue inside the chamber 16. Passage of water into each sprayer 10 causes rotation of the respective head and jet discharge of spray around the inside of the chamber 16. The fourth combined prime mover and pump 22 is also energised to supply pressurized water to the lance sprayer for the outside of the pan mixer to be washed. An ON/OFF control switch may be provided at the base of the lance sprayer.

Alternatively, the diverter valve 30 is switched from the second port to third port to supply water to the lance sprayer 28.

In a first modification, water to be introduced into the concrete mixer to be mixed with cement powder may be introduced through three pipes one in each of three locations, one location adjacent to each sprayer 10 with the water playing on each nozzle to wash any cement dust off the nozzles prior to the mixer mixing the cement, sand and water. Additionally, a water meter may be integrated into the water pipe feeding the three pipes and controlled to hold back an amount of water which can be introduced into the chamber after the cement is mixed but shortly before it is discharged.

Variations and other modifications can be made without departing from the scope of the invention described above and as claimed hereinafter.

1-7. (canceled)

8. A pan type concrete mixer comprising a pan defining a mixing chamber, a top wall defining a cover or lid for the pan, a plurality of sprayers inserted in a substantially equi-spaced arrangement in a wall of the pan to extending into the mixing chamber, each sprayer having a head with at least one jet nozzle, each head being capable of substantially 360° rotation, each sprayer being connectable to a pressurized water supply whereby passage of water into each sprayer causes rotation of the respective head and jet discharge of spray around the inside of the chamber.

9. A concrete mixer as claim in claim 8, wherein the sprayers are mounted in the top wall or lid of the pan.

10. A concrete mixer as claimed in claim 9, wherein the head of each sprayer has two diametrically opposite jet nozzles.

11. A concrete mixer as claimed in claim 8, further comprising a unit further including a framework in which a corresponding combined prime mover and pump is provided for each sprayer.

12. A concrete mixer as claimed in claim 9, further comprising a unit further including a framework in which a corresponding combined prime mover and pump is provided for each sprayer.

13. A concrete mixer as claimed in claim 10, further comprising a unit further including a framework in which a corresponding combined prime mover and pump is provided for each sprayer.

14. A concrete mixer as claimed in claim 11, further comprising a tank for holding water above said combined prime movers and pumps with each pump being supplied with water therefrom, the pumps each communicating with the respective sprayer.

15. A concrete mixer as claimed in claim 12, further comprising a tank for holding water above said combined prime movers and pumps with each pump being supplied with water therefrom, the pumps each communicating with the respective sprayer.

16. A concrete mixer as claimed in claim 13, further comprising a tank for holding water above said combined prime movers and pumps with each pump being supplied with water therefrom, the pumps each communicating with the respective sprayer.

17. A concrete mixer as claimed in claim 11, wherein one of said combined prime mover and pumps is provided with a three port diverter valve, one port being connected to the tank, a second port to a sprayer and a third port connected to a lance sprayer for use in cleaning the outside of the mixer, the valve being operable to divert water from the second port to the third port and vice versa.

18. A concrete mixer as claimed in claim 12, wherein one of said combined prime mover and pumps is provided with a three port diverter valve, one port being connected to the tank, a second port to a sprayer and a third port connected to a lance sprayer for use in cleaning the outside of the mixer, the valve being operable to divert water from the second port to the third port and vice versa.

19. A concrete mixer as claimed in claim 13, wherein one of said combined prime mover and pumps is provided with a three port diverter valve, one port being connected to the tank, a second port to a sprayer and a third port connected to a lance sprayer for use in cleaning the outside of the mixer, the valve being operable to divert water from the second port to the third port and vice versa.

20. A concrete mixer as claimed in claim 14, wherein one of said combined prime mover and pumps is provided with a three port diverter valve, one port being connected to the tank, a second port to a sprayer and a third port connected to a lance sprayer for use in cleaning the outside of the mixer, the valve being operable to divert water from the second port to the third port and vice versa.

21. A concrete mixer as claimed in claim 15, wherein one of said combined prime mover and pumps is provided with a three port diverter valve, one port being connected to the tank, a second port to a sprayer and a third port connected to a lance sprayer for use in cleaning the outside of the mixer, the valve being operable to divert water from the second port to the third port and vice versa.

22. A concrete mixer as claimed in claim 16, wherein one of said combined prime mover and pumps is provided with a three port diverter valve, one port being connected to the tank, a second port to a sprayer and a third port connected to a lance sprayer for use in cleaning the outside of the mixer, the valve being operable to divert water from the second port to the third port and vice versa.

23. A concrete mixer as claimed in claim 17, wherein the valve is electrically-operable.

24. A concrete mixer as claimed in claim 18, wherein the valve is electrically-operable.

25. A concrete mixer as claimed in claim 19, wherein the valve is electrically-operable.

26. A concrete mixer as claimed in claim 20, wherein the valve is electrically-operable.

27. A concrete mixer as claimed in claim 21, wherein the valve is electrically-operable.
